(19) United States
(12) Patent Application Publication
(10) Pub. No.: US 2012/0207971 A1
(43) Pub. Date: Aug. 16, 2012

(54) BUFFER SUBSTRATE, BUFFER SHEET AND MANUFACTURING METHOD THEREOF

(75) Inventor: Kyu Won LEE, Seoul (KR)

(73) Assignee: HYNIX SEMICONDUCTOR INC., Icheon-si (JP)

(21) Appl. No.: 13/365,359

(22) Filed: Feb. 3, 2012

(30) Foreign Application Priority Data
Feb. 15, 2011 (KR) 10-2011-0013479

(51) Int. Cl. B32B 3/10; B32B 9/04; B32B 27/06; B32B 37/02; B32B 37/10

(52) U.S. Cl. 428/139; 156/281; 428/473.5; 428/447

(57) ABSTRACT

Disclosed herein is a buffer substrate comprising: a first substrate having a first surface and a second surface opposite to the first surface, the first substrate having one or more through-holes formed therein; a first elastic material component filling the through-holes and covering the second surface of the first substrate; and a second substrate arranged on the first elastic material component arranged on the second surface of the first substrate.

### CROSS-REFERENCES TO RELATED APPLICATIONS

The present application claims priority under 35 U.S.C. 119(a) to Korean Application No. 10-2011-0013479, filed on Feb. 15, 2011, in the Korean Intellectual Property Office, which is incorporated herein by reference in its entirety.

### BACKGROUND

Exemplary embodiments of the present invention relate generally to a buffer substrate, a buffer sheet which may be used together with the buffer substrate, and a method for manufacturing the buffer substrate, and more particularly to a buffer substrate for semiconductor packages, a buffer sheet which may be used together with the buffer substrate, and a method for manufacturing the buffer substrate.

A semiconductor chip having a plurality of integrated electrical circuits cannot be used by itself as a finished product because it can be damaged by external physical or chemical impact. Thus, the semiconductor chip is mounted on and electrically connected to a substrate (lead frame or printed circuit board) and is encapsulated with, for example, EMC (Epoxy Molding Compound), such that it can be protected from external moisture or impurities.

FIG. 1 is a cross-sectional view showing a process of manufacturing a semiconductor package according to a known art. As shown in FIG. 1, a semiconductor chip 40 is attached by an adhesive 30 to a package substrate 10 having ball lands 20 formed thereon and is electrically connected to the package substrate 10 by bonding wires 50. Then, the semiconductor chip 40 is generally molded with an epoxy molding compound (EMC) 60, thereby manufacturing a semiconductor package.

With increasing use of small-size and light-weight semiconductor packages, the thickness (T) of the package substrate is reaching about 80 μm and the step height (t) of the ball land is reaching about 10˜15 μm, whereas the width (W) of the ball land remains at about 1,000 μm. For this reason, the ball land 20 may be bent due to pressure applied during the semiconductor package molding process. This may be referred to as a fluctuation. When the ball land 20 protrudes out of the package substrate 10 due to this fluctuation, they can be scratched. In order to alleviate this phenomenon, the step height (t) of the ball land 20 can be reduced, but in this case, the mold can be contaminated with the metal of the ball land.

### SUMMARY

An embodiment of the present invention relates to a buffer substrate which can prevent the fluctuation of a ball land and the contamination of a mold during semiconductor package molding, as well as a buffer sheet which may be used together with the buffer substrate, and a method for manufacturing the buffer substrate.

In one embodiment, a buffer substrate includes a first substrate having one surface and the other surface opposite to the one surface, the first substrate having one or more through-holes formed therein; a first elastic material filling the through-holes and covering the other surface of the first substrate; and a second substrate deposited on the other surface of the first substrate with the first elastic material interposed therebetween.

The buffer substrate may further include a cover film deposited on the one surface of the first substrate.

The first elastic material may cover the one surface of the first substrate and include a silicone rubber, an elastomer or a thermoplastic resin. Specifically, the first elastic material may be a thermoplastic elastomer including any one or more of a thermoplastic olefin elastomer (TPO), a styrenic block copolymer (SBC), a thermoplastic polyurethane (TPU), a thermoplastic polyamide (TPAE) and a thermoplastic polyester elastomer (TPEE).

The first substrate may include any one or more of stainless steel (SUS), epoxy resin, polyimide resin and aramid resin.

Another embodiment of the present invention relates to a buffer sheet including a flexible film and a second elastic material deposited on one surface of the flexible film.

In one embodiment, the buffer substrate may include the buffer sheet. Specifically, the buffer substrate may further include, on one surface of the first elastic material, the buffer sheet including the flexible film and the second elastic material deposited on one surface of the flexible film.

In another embodiment, the flexible film may include polyimide resin, and the second elastic material may include a silicone rubber, an elastomer or a thermoplastic resin. More specifically, the second elastic material may be a thermoplastic elastomer including any one or more of a thermoplastic olefin elastomer (TPO), a styrenic block copolymer (SBC), a thermoplastic polyurethane (TPU), a thermoplastic polyamide (TPAE) and a thermoplastic polyester elastomer (TPEE).

Another embodiment of the present invention relates to a method for manufacturing a buffer substrate, the method including forming one or more through-holes in a first substrate having one surface and the other surface opposite to the one surface, such that the through-holes extend from the one surface to the other surface; applying a first elastic material to one surface of a second substrate; and compressing the first elastic material toward the other surface of the first substrate to inject the first elastic material into the through-holes.

In one embodiment, the applying of the first elastic material of the manufacturing method of the present invention may be performed by thermal compression.

In another embodiment, the manufacturing method of the present invention may further include, after the applying of the first elastic material, applying a second elastic material to the one surface of the first substrate.

In another embodiment, the first elastic material and the second elastic material may be the same material and may include, for example, any one or more of a silicone rubber, an elastomer and a thermoplastic resin.

In another embodiment, the manufacturing method of the present invention may further include, after the applying of the first elastic material, depositing a cover film on the one surface of the first substrate.

### BRIEF DESCRIPTION OF THE DRAWINGS

The above and other aspects, features and other advantages will be more clearly understood from the following detailed description taken in conjunction with the accompanying drawings, in which:

FIG. 1 is a cross-sectional view illustrating a process of a semiconductor package according to a known art;

FIG. 2 is a perspective view of a buffer substrate according to an embodiment of the present invention;

FIG. 3 is a cross-sectional view of portion A of FIG. 2;

FIG. 4 is a perspective view of a buffer sheet according to an embodiment of the present invention;

FIGS. 5A to 5E are cross-sectional views illustrating each step of a method for manufacturing a buffer substrate according to an embodiment of the present invention;

FIGS. 6A to 6D are cross-sectional views illustrating a method for molding a semiconductor package using a buffer substrate and a buffer sheet according to an embodiment of the present invention; and

FIG. 7 is a cross-sectional view showing a package molding process that is carried out after deposition of a buffer substrate.

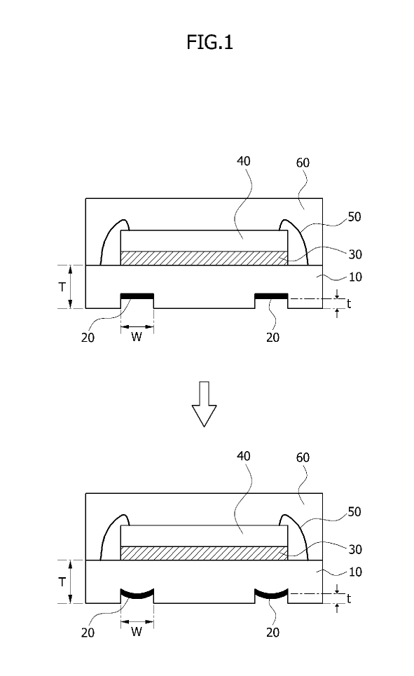

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention. In the drawings, the size and relative sizes of layers and regions may be exaggerated for clarity. It will be understood that when an element or layer is referred to as being “on” another element or layer, the element or layer can be directly on another element or layer or intervening elements or layers. In addition, spatially relative terms, such as “below,” “lower,” “above,” and “upper” and the like, may be used herein for ease of description to describe the relationship of one device or element to another device (s) or element (s) as illustrated in the drawings. It will be understood that the spatially relative terms are intended to encompass different orientations of the device in use or operation, in addition to the orientation depicted in the drawings.

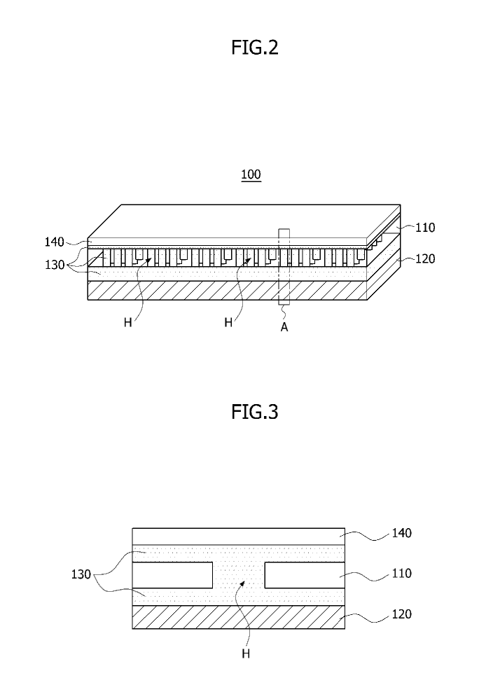

FIG. 2 is a perspective view of a buffer substrate according to an embodiment of the present invention, and FIG. 3 is a cross-sectional view of portion A of FIG. 2. As shown in FIGS. 2 and 3, a buffer substrate 100 according to an embodiment of the present invention comprises a first substrate 110, a second substrate 120 and a first elastic material component 130 and may further comprise a cover film 140. Although the first substrate 110 is not transparent, through-holes (H) in the first substrate 110 is shown in FIG. 2 for explanatory purposes.

One or more through-holes (H) are formed in the first substrate 110, and the first elastic material component 130 fills the through-holes (H) while covering one surface (upper surface) of the first substrate and the other surface opposite to the one surface. The through-holes (H) may be formed so as to correspond to the positions of ball lands.

The material of the first substrate 110 or the second substrate 120 is not limited. For example, the first substrate 110 or the second substrate 120 may include one or more of metal, plastic and ceramic materials and may include a material having a monolayer or multilayer structure. Specifically, the first substrate 110 or the second substrate 120 may be formed of a material comprising one or more of stainless steel (SUS), epoxy resin, polyimide resin and aramid resin. The material comprising the epoxy resin may be a glass-containing epoxy resin, and the material comprising the aramid resin may be a material comprising an aramid fiber. Also, the first substrate 110 and the second substrate 120 may be formed of the same or different materials.

As the first elastic material component 130, any material may be used so long as it shows elasticity. For example, the first elastic material component 130 may comprise one or more of a silicone rubber, an elastomer and a thermoplastic resin. Examples of the elastomer include natural rubbers such as polyisoprene, as well as polybutadiene, polyisobutylene, polyurethane, etc. The thermoplastic resin may be, but not limited to, a thermoplastic elastomer (TPE). Specifically, the thermoplastic resin may include one or more of a thermoplastic olefin elastomer (TPO), a styrenic block copolymer (SBC), a thermoplastic polyurethane (TPU), a thermoplastic polyamide (TPAE) and a thermoplastic polyester elastomer (TPEE).

The cover film 140 may be provided to protect the first elastic material component and can be removed when the buffer substrate is to be used. The cover film 140 may be formed of any material. For example, the cover film 140 may include one or more of polyethylene terephthalate (PET), polyethylene naphthalate (PEN), polyether sulfone (PES), polyarylate (PAR), polycarbonate (PC), a cycloolefin copolymer (COC), and polyimide (PI).

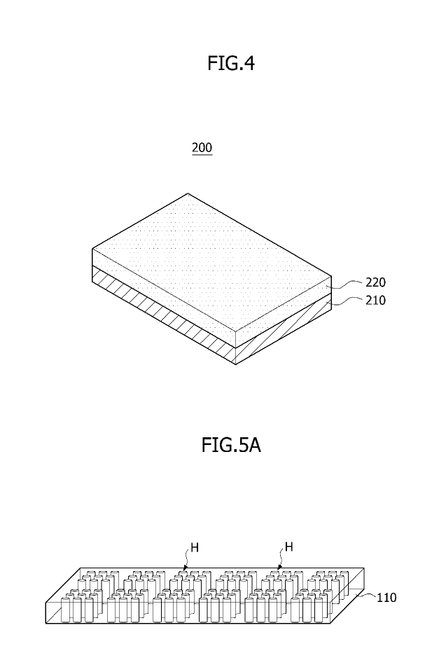

FIG. 4 is a perspective view of a buffer sheet according to an embodiment of the present invention. As shown in FIG. 4, a buffer sheet 200 according to an embodiment of the present invention may have a structure in which a second elastic material component 220 is arranged on one surface of a flexible film 210. In addition, a protective film (not shown) may be arranged on one surface (upper surface) of the second elastic material.

The flexible film 210 may be a metal or plastic film. Also, it may be a flexible plastic film. For example, it may be a film comprising one or more of polyethylene terephthalate (PET), polyethylene naphthalate (PEN), polyether sulfone (PES), polyarylate (PAR), polycarbonate (PC), a cycloolefin copolymer (COC), and polyimide (PI).

As the second elastic material component 220, any material may be used so long as it shows elasticity. For example, the second elastic material component 220 may comprise one or more of a silicone rubber, an elastomer and a thermoplastic resin. Examples of the elastomer include natural rubbers such as polyisoprene, as well as polybutadiene, polyisobutylene, polyurethane, etc. The thermoplastic resin may be, but not limited to, a thermoplastic elastomer (TPE). Specifically, the thermoplastic resin may include one or more of a thermoplastic olefin elastomer (TPO), a styrenic block copolymer (SBC), a thermoplastic polyurethane (TPU), a thermoplastic polyamide (TPAE) and a thermoplastic polyester elastomer (TPEE). The first elastic material component 130 and the second elastic material component 220 may be made of the same or different materials.

The buffer sheet 200 may be used separately from the buffer substrate 100. Alternatively, it may also be attached to the buffer substrate 100. Specifically, although not shown in the drawings, the buffer substrate 100 according to an embodiment of the present invention may further comprise, on one surface of the first elastic material, the buffer sheet comprising the flexible film and the second elastic material component arranged on one surface of the flexible film. Here, the first elastic material component and the flexible film can be bonded to each other by an adhesive, and after use of the buffer substrate, the buffer sheet comprising the flexible film and the second elastic material component may be separated and removed. That is, the buffer sheet may be disposable.

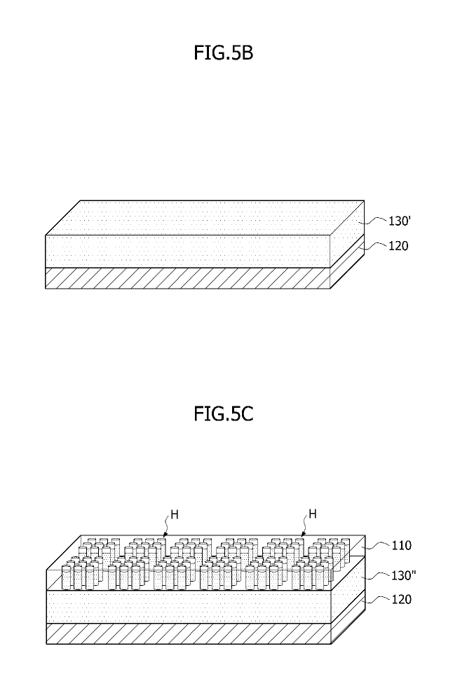

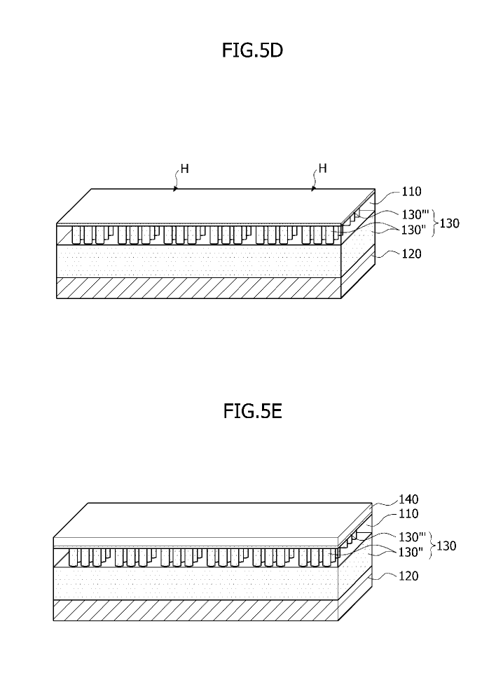

FIGS. 5A to 5E are cross-sectional views illustrating each step of a method for manufacturing a buffer substrate according to an embodiment of the present invention. Hereinafter, the present invention will be described with reference to FIGS. 5A to 5E, but the descriptions overlapping with those as described above will be omitted or briefly explained herein.

Referring to FIG. 5A, one or more through-holes (H) are formed in a first substrate 110 having one surface and the other surface opposite to the one surface, such that the through-holes extend from the one surface to the other surface. The through-holes (H) can be formed by any method. For example, the through-holes can be formed by laser or mechanical drilling. Alternatively, the through-holes can be formed using a semiconductor photography process. Specifically, the through-holes can be formed by applying a photoresist to the first substrate, exposing and developing the applied photoresist to form a photoresist pattern, and performing an etching process using the photoresist pattern as an etch mask. Examples of the etching process include deep reactive ion etching (DRIE).

Referring to FIG. 5B, a first elastic material component 130′ is applied to one surface (or both surfaces) of a second substrate 120. The first elastic material component 130′ may be a material constituting the first elastic material component 130 described above (or below).

The first elastic material component 130 can be applied by any method. For example, the first elastic material component 130 can be applied using a spin coating, dip coating, dispensing or screen printing method. For example, when the first elastic material component 130′ is a silicone rubber (silicon-containing rubber), a silicone rubber composition comprising silica, a vinyl-based polymer, a coupling agent, a catalyst, a filler and the like may be applied to the second substrate.

Referring to FIG. 5C, the first elastic material component 130′ is compressed toward the other surface (lower surface) of the first substrate 110 so as to inject a first elastic material component 130″ into the through-holes. Here, the compression may be thermal compression. For example, when the first elastic material component 130″ is a thermoplastic resin, the flowability thereof can increase by heating, and injection of the first elastic material component 130″ into the through-holes (H) can be facilitated. Here, the first elastic material component 130″ may fill all or part of the through-holes (H). In FIG. 5C, part of the through-holes is shown to be filled.

Referring to FIG. 5D, a second elastic material component 130′″ may be applied to the one surface (upper surface) of the first substrate 110. Although the first elastic material component 130″ can fill all the through-holes (H) in the above-described injection process (FIG. 5C), part of the through-holes (H) cannot be filled. In this case, the second elastic material component 130′″ may be applied such that it fills all the through-holes H while it covers the one surface of the first substrate 110. The first elastic material component 130″ and the second elastic material component 130′ form the above-described first elastic material component 130. The first elastic material component 130″ and the second elastic material component 130′″ may be formed of different materials or may be formed of the same material. Examples of the first elastic material component 130″ and the second elastic material component 130′ are the same as described above, and thus the description thereof will be omitted.

Referring to FIG. 5E, a cover film 140 may be arranged on one side of the first substrate 110. The cover film 140 can be attached to the first elastic material component 130 by an adhesive (not shown) and may be removed when the buffer substrate is to be used.

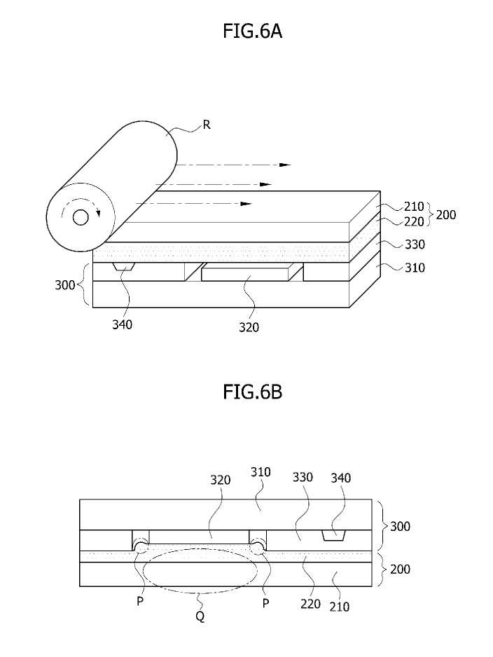

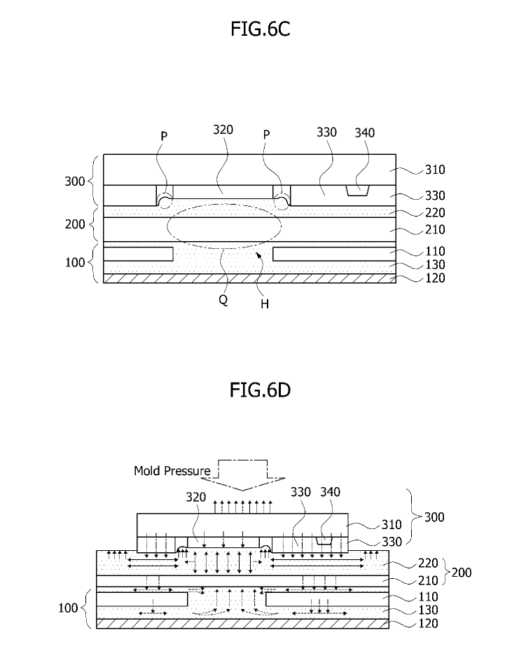

FIGS. 6A to 6D are cross-sectional views illustrating a method for molding a semiconductor package using a buffer substrate and a buffer sheet according to an embodiment of the present invention. Hereinafter, the present invention will be described with reference to FIGS. 6A to 6D, but the descriptions overlapping with those as described above will be omitted or briefly explained herein.

Referring to FIG. 6A, a protective film (not shown) is removed from a buffer sheet 200, and a second elastic material component 220 can be compressed toward the ball land of a package substrate 300. The package substrate 300 may comprise a substrate core 310, a ball land 320, a solder resist 330 and a circuit pattern. Here, the thickness of the ball land 320 may be smaller than that of the solder resist 330 so that the ball land 320 and the solder resist 330 form a stepped structure. The structure of the package substrate shown in FIG. 6A is merely one example, and a package substrate having a structure different from that shown in FIG. 6A may be used in the present invention. Also, a printed circuit board (PCB) may be used in place of the package substrate. Alternatively, other structures including a ball land having a stepped structure may be used in place of the package substrate.

The buffer sheet 200 may be compressed by any method. For example, the compression may be carried out by a lamination method using a roller (R) as shown in FIG. 6A, but other methods may be used.

FIG. 6B shows the buffer sheet compressed toward the package substrate. As shown in FIG. 6B, the second elastic material component 220 and the flexible film 210 can be deformed as the buffer sheet 200 is compressed. In other words, portions of the second elastic material component 220, which correspond to the spaces between the ball land 320 and solder resist 330 of the package substrate 300, can be pushed up into the spaces by the compressed force to form protrusions (P), and portions of the second elastic material component 220 and the flexible film 210, which correspond to the position of the ball land 320, can also be pushed up toward the ball land 320 so as to form a curved portion (Q).

FIG. 6C is a cross-sectional view showing the buffer substrate arranged on the buffer sheet. After removing the cover film 140, the buffer substrate 100 comprising the first substrate 110, the second substrate 120 and the first elastic material component 130 may be arranged beneath the buffer sheet in such a manner that the through-hole (H) in the buffer substrate 100 is positioned so as to correspond to the ball land 320. Therefore, the buffer sheet 200 can function to primarily reduce/minimize deformation of the ball land of the package substrate, and the buffer substrate can serve to support this function of the buffer sheet.

FIG. 6D is a cross-sectional view illustrating the functions and effects of the buffer sheet and the buffer substrate when package molding is carried out after arranging the buffer sheet and the buffer substrate. In FIG. 6D, the force caused by mold pressure is indicated by an alternate long and short dash line arrow, the force of the buffer sheet against mold pressure is indicated by a solid line arrow, and the force of the buffer substrate against mold pressure is indicated by a dotted line arrow.

As shown in FIG. 6D, the protruding solder resist 330 receives higher pressure than the ball land 320 by mold pressure, and thus the second elastic material component 220 having flexibility and elasticity receives a force in the horizontal direction, whereby the second elastic material component 220 can be pushed up into the spaces between the ball land 320 and the solder resist 330. In addition, a force can be applied such that the second elastic material component 220 arranged beneath the ball land 320 reduce/minimize deformation of the ball land 320. Also, the buffer substrate placed beneath the second elastic material component 220 may reduce/minimize deformation of the ball land 320.

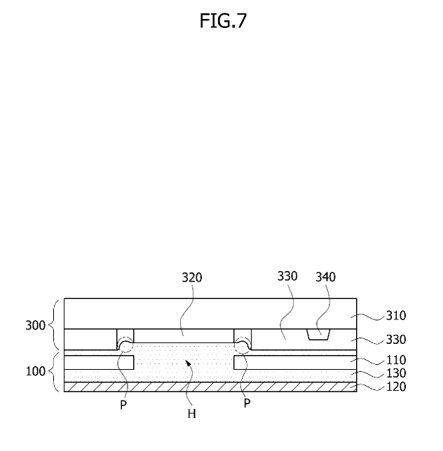

FIG. 7 is a cross-sectional view showing a package molding process that is carried out after arranging the buffer substrate. A process of molding a semiconductor package may be performed using the buffer substrate 100 alone. In other words, the semiconductor package molding process may be performed, after the buffer substrate has been arranged such that the through-hole (H) in the buffer substrate 100 is positioned at a place corresponding to the ball land 320. In the deposition process, pressure may not be applied to the buffer substrate 100. When mold pressure is applied during the molding process, portions of the first elastic material component 130, which correspond to the spaces between the ball land 320 and solder resist 330 of the package substrate 300, can be pushed up into the spaces by the pressed force to form protrusions (P), and portions of the first elastic material component 130 and the second substrate 120, which correspond to the position of the ball land 320, can be pushed up toward the ball land 320 to form a curved portion (not shown).

As described above, the buffer substrate 100 according to an embodiment of the present invention may be used alone or in combination with the buffer sheet 200. In some embodiment of the present invention, the buffer substrate 100 may refer to the buffer sheet 200 attached thereto. Although it has been described above that the buffer substrate is used alone or in combination with the buffer sheet so as to reduce/minimize deformation of the ball land during semiconductor package molding, the buffer substrate and the buffer sheet may also be used to reduce/minimize deformation of structures in various applications in addition to the semiconductor package molding process.

As described above, the buffer substrate and buffer sheet of the present invention may reduce/minimize deformation of the ball land and contamination of the mold during semiconductor package molding, thereby improving the manufacturing yield of semiconductor packages.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A buffer substrate comprising:
a first substrate having a first surface and a second surface opposite to the first surface, wherein the first substrate has one or more through-holes formed therein;
a first elastic material component filling the through-holes and covering the second surface of the first substrate; and
a second substrate arranged on the first elastic material component arranged on the second surface of the first substrate.

2. The buffer substrate of claim 1, wherein the buffer substrate further comprises a cover film arranged on the first surface of the first substrate.

3. The buffer substrate of claim 1, wherein the first elastic material component covers the first surface of the first substrate.

4. The buffer substrate of claim 1, wherein the first elastic material component comprises a silicone rubber, an elastomer or a thermoplastic resin.

5. The buffer substrate of claim 1, wherein the first elastic material component is a thermoplastic elastomer comprising one or more of a thermoplastic olefin elastomer (TPO), a styrenic block copolymer (SBC), a thermoplastic polyurethane (TPU), a thermoplastic polyamide (TPAE) and a thermoplastic polyester elastomer (TPEE).

6. The buffer substrate of claim 1, wherein the first substrate comprises one or more of stainless steel (SUS), epoxy resin, polyimide resin and aramid resin.

7. The buffer substrate of claim 1, wherein the buffer substrate further comprises a buffer sheet arranged on the first surface of the first elastic material, wherein the buffer sheet comprises a flexible film and a second elastic material component arranged on a first surface of the flexible film.

8. The buffer substrate of claim 7, wherein the flexible film comprises polyimide resin.

9. The buffer substrate of claim 7, wherein the second elastic material component comprises a silicone rubber, an elastomer or a thermoplastic resin.

10. The buffer substrate of claim 7, wherein the second elastic material component is a thermoplastic elastomer comprising one or more of a thermoplastic olefin elastomer (TPO), a styrenic block copolymer (SBC), a thermoplastic polyurethane (TPU), a thermoplastic polyamide (TPAE) and a thermoplastic polyester elastomer (TPEE).

11. A buffer sheet comprising:
a flexible film; and
an elastic material component arranged on a surface of the flexible film.

12. The buffer sheet of claim 11, wherein the flexible film comprises polyimide resin.

13. The buffer sheet of claim 11, wherein the second elastic material component comprises a silicone rubber, an elastomer or a thermoplastic resin.

14. The buffer sheet of claim 11, wherein the second elastic material component is a thermoplastic elastomer comprising one or more of a thermoplastic olefin elastomer (TPO), a styrenic block copolymer (SBC), a thermoplastic polyurethane (TPU), a thermoplastic polyamide (TPAE) and a thermoplastic polyester elastomer (TPEE).

15. A method for manufacturing a buffer substrate, the method comprising:
forming one or more through-holes in a first substrate having a first surface and a second surface opposite to the first surface, such that the through-holes extend from the first surface to the second surface;
applying a first elastic material component to a first surface of a second substrate; and
compressing the first elastic material component toward the second surface of the first substrate so as to inject the first elastic material component into the through-holes.

16. The method of claim 15, wherein the application of the first elastic material component is performed by thermal compression.

17. The method of claim 15, wherein the method further comprises, after applying the first elastic material, applying a second elastic material component to the first surface of the first substrate.

18. The method of claim 17, wherein the first elastic material component and the second elastic material component are formed of the same material.

19. The method of claim 17, wherein one or more of the first elastic material component and the second elastic material
